(19) United States
(12) Patent Application Publication
(10) Pub. No.: US 2009/0144108 A1
(43) Pub. Date: Jun. 4, 2009

(54) System for commoditization of information through centralized communication between advertisers, internet service providers or similar entities, consumers, and financial institutions

(76) Inventor: Douglas Richard Cloud, Gig Harbor, WA (US)

Correspondence Address: Douglas Richard Cloud, Suite 101, 901 South I Street, Tacoma, WA, 98405, US

(21) Appl. No.: 12/001,052

(22) Filed: Nov. 28, 2007

(51) Int. Cl. G06Q 10/00; G06Q 30/00

(52) U.S. Cl. 705/7; 705/14; 705/400

(57) ABSTRACT

A method for commodisizing information that utilizes market based or auction pricing to establish the value of both advertising and non-advertising content consumed by specific individuals. The integration of these two market values through centralized information providers, together with the use of a transactions instrument which contains biographical and financial information pertaining to a specific consumer, allows for specific market derived individual prices to be set for every piece of information consumed by an individual of whatever type.

### CROSS-REFERENCE TO RELATED APPLICATIONS

None.

### FEDERALLY SPONSORED RESEARCH

Not Applicable.

### SEQUENCE LISTING OR PROGRAM

Not Applicable.

### BACKGROUND OF THE INVENTION

1. Field or Invention

This invention generally relates to the exchange of information through any system for the delivery of information to potential consumers. This invention will allow for individual pricing for information received by specific consumers and the pricing of advertising directed to those specific consumers through the use of an integrated market based or auction system to set the value of the information provided to individual consumers at specific times as well as to ascertain the value of advertising to advertisers at specific times. The method described herein is applicable to any information delivery system such as by electronic means through the internet, radio, broadcast television, mobile phones, handheld communication devices, magazines and newspapers. This system would allow advertisers to bid to send specific information to specific consumers, as well as to allow consumers the opportunity to capture advertising revenue directly or indirectly based upon their financial and personal profile as established through the use of a financial transaction instrument, such as a device like a bank credit card or bank debit card or any device functioning as described herein. The system described herein provides for the maximum economic efficiencies to all parties to the communication process; the recipient of information, the sender of information, the advertiser whose message accompanies the communication and the creator of the non-advertising content communicated.

The invention described herein has many benefits over existing systems. Adoption of this system will foster a much freer and more independent media. Advertisers and content providers in this system would have little control over each other's message.

The system described herein allows for a measurement of the importance of specific information sent to specific people through the establishment of market values for such information.

The system described herein provides an ability to advertisers to be more selective and effective with their advertising. It will enable advertisers to be more efficient. It will allow an infinite variability in the amount and intensity of information communicated to specific information consumers.

2. Prior Art

There are existing systems pertaining to the provision of advertising or information services through the Internet or electronic means to consumers. None of those systems, however, fully integrate a method for direct advertising to consumers, which allows the consumers to systematically capture a portion of the advertising dollars directed at them, regardless of the information delivery or communication system utilized. The system described herein is a fully integrated system that allows advertisers to bid to provide information to specific consumers and to allow consumers to capture some and ultimately most if not all of the advertising dollars that are directed towards them. Conversely, none of the existing systems allow for a full integration of financial information, advertising information and general information, such that all can be combined in one system to provide the most efficient means possible of directing communication to a consumer and back to an advertiser, such that the efficiency of the information markets can be maximized.

Internet or electronic service providers already have some ability to direct specific advertising to specific consumers. However, there is no instantaneous universal market mechanism which provides a specific monetary market value for the information received by a consumer at a specific time regardless of the communication delivery system utilized. Moreover, there is no specific system available which allows advertisers to bid on specific consumers regardless of the content provided or the information delivery system utilized. The system proposed herein would fully integrate all information provided over the Internet or any other information delivery system, such that each bit of information would have a market value as established by the market or by auction amongst the various bidders competing for a specific consumer's attention.

The system described herein further contemplates that centralized information providers such as internet service providers, cable companies, newspapers, or broadcasters will also bid to attract information consumers' business. Centralized information providers will provide price competition for information consumers as an intermediary but all centralized information providers in this system will ultimately see their margins compressed with competition; resulting in an increasing proportion of the advertising dollar flowing directly to the consumer. Ultimately all of the advertiser's consideration paid less than the transaction cost of transmitting information will flow directly to the consumer.

### OBJECTS AND ADVANTAGES

Besides the objects and advantages of the system described in the previous section, a prime object and advantage of the present invention is that centralized information providers would be less able to control advertising or other information content directed to a specific individual. Each advertiser would, in essence, bid on or pay the market price of each bit of information provided to each specific consumer independent of the entertainment, information or other content provided. The advantage of this would be to establish less advertiser influence on the media or centralized information provider resulting in a freer media such that the advertisers would be unable or less able to control the content provider's information content and, conversely, the content provider would be unable or less able to control the advertising directed to the consumer on any basis other than price. The information consumer will also be able to determine herself how much advertising or commercial content she is willing to consume. The fundamental mechanism to allocate specific advertising to a specific consumer would be a market based auction system or a market based system generally, which will allow the value of the information conveyed to have a specific monetary value at a specific point in time, such that each bit of information is properly valued so as to maximize the efficiency of the market for information at any given time. Essentially, this patent would accomplish a total commoditization of information such that the advertising decision would be independent of the content decision but would be dependent upon the value of the advertising to be transmitted to and received by a specific consumer. Advertising directed to a specific consumer has a specific value for each specific centralized information delivery system and each advertiser. Rather than allowing for a blanket price of advertising or content to a group of undifferentiated persons as is the present tendency, this system would allow a more precise measurement of advertising value to a specific advertiser or to a specific consumer or identified group of consumers. This system will compensate more directly people for the loss of time the consumption of advertising entails. Some consumers may chose not to view any advertising or commercial content while others may choose to only view commercial or advertising content, in order to maximize the amount of money paid for their time in consuming such content.

The system will result in a more accurate or perfect price for information, allowing the information markets to become infinitely more efficient, which will result in greater wealth throughout any economy utilizing the system.

The system, in an alternative form, also allows for an individual commodity and service pricing mechanism for any market. Every market is an information market with a primary part of the information conveyed being price. The system described in this patent allows for direct bidding on a consumer's time by any good or service or message provider at any time. This allows any market for anything, be it a good, a service, or a message, to approach a complete individual pricing model such that any market can benefit from the efficiencies of the system described in this patent application. The information consumer's biographical and financial history, as encapsulated in his transaction instruments, and associated computerized database, provides the information a merchant needs to price his wares individually, i.e., a different price for every consumer is now possible.

Further objects and advantages of my invention will become apparent from a consideration of the drawings and the descriptions herein.

### SUMMARY

In accordance with the invention, it is the object of this invention to allow for a full market based system for the buying and selling of all information which would allow for a more efficient market based pricing for all information. The invention also contemplates capturing the ultimate efficiency available in pricing advertising and information content. The ultimate end consumer of information will receive compensation from advertisers for viewing content upon which the advertisers bid for the consumer's time and business and/or attention.

Individual pricing of any good and service to unique consumers will be facilitated by the inventions alternate embodiment.

### DESCRIPTION OF DRAWINGS

FIG. 1 is a flow sheet representation of the invention in it's preferred embodiment. A more detailed and complete description of the individual boxes within the flow sheet is provided for within the Detailed Description—Preferred Embodiment and Operation—Preferred Embodiment—FIG. 1 section herein.

FIG. 2 is a flow sheet representation of the invention in it's alternative embodiment. A more detailed description of the individual boxes within the flow sheet is provided for within the Description—Alternative Embodiment and Operation—Alternative Embodiment—FIG. 2.

### DETAILED DESCRIPTION

### Preferred Embodiment

In order to allow for full commoditization of information exchanged between consumers, advertisers or other message providers and content providers, it is necessary that a system be developed to allow for a specific market price to be set for each specific consumer at each specific point in time during which that individual is receiving information. A mechanism must also be established to value non-advertising content and its consumption by specific consumers at specific times. The value of information received by the consumer and the value of any advertising provided by an advertiser varies to an infinite extent depending upon each discreet consumer and that consumer's economic situation and that consumer's interest level in the particular content, information or advertising provided at the time provided. The present system allows for some crude efficiencies, but nothing as comprehensive as suggested in this patent application.

This patent application, essentially, calls for an auction based or market system to be established by each centralized information provider, which are currently evidenced most commonly as internet service providers, radio, broadcast television and cable television and the old line print media. The system proposed herein, however, is not limited to existing media applications as future technological growth could render the transmission of information through present means obsolete. The system suggested herein, however, would not be obsolete. It is proposed that each centralized information provider, allow information consumers to be bid on by specific advertisers or bidders at specific times. The consideration bid will depend upon the advertising and content provided to the consumer at the time upon which it is provided. In order to maximize the efficiency of this system, it is necessary that there be free sharing of consumer financial and biographical information with potential advertisers or bidders who will find value in directing advertising and communication to specific consumers, together with an auction system or market based system for allocating compensation paid for access to specific consumers. The system would also allow for those consumers with limited advertiser appeal to be charged for content based upon their worth (or non-worth) to advertisers or others bidding for their time. Thus, each individual consumer to some extent will have an individual market value for information received depending upon his financial circumstances, spending habits, spending history, and expressed interest in products to be advertised and information to be communicated. As information is received by a consumer or requested by a consumer, specific price points could be bid instantly or shortly before transmission of said information from the centralized information provider to set a price for that information in terms of market value of the information received and/or the advertising provided. For instance, the information consumer can seek to view a particular piece of information. He can request the content from a centralized information provider. The content provider will either accept or reject the price being offered by the centralized information provider on behalf of the information consumer. The centralized information provider will also, at the same time, seek advertisers' bids for advertising to accompany the content provided the consumer. The advertising will pay for all, part, or more than the cost agreed to by the content provider. If the advertiser pays less, the shortfall will be paid by the consumer, ultimately. Content providers can participate in a bid/ask/auction market or they can contract directly with information content providers to provide content per an agreed price schedule as set by a competitive market.

The system, by necessity, involves the revealing of historical biographical and financial information and spending patterns by the information consumer. In return for sharing this information with the centralized information provider or anyone bidding for the consumer's attention the consumer has the possibility of capturing some of the advertising funds directed at him. Thus, as individual financial profiles and spending patterns emerge and are provided to advertisers to bid upon at specific times, the flow of advertising money will reach directly to the consumer who can decide or not to view the advertising depending upon the value received by him for viewing that information either in the form of direct financial compensation or indirect free content.

Each consumer who participates in the system must be assigned a discreet identification number or other identifying mark or character. The identification could be a fingerprint, an account number, a transaction card, or anything that is unique to each person. Moreover, even more intrusive ways of ensuring a potential consumer views the proffered advertising such as the use of eye scans or scans of other body parts, could be utilized.

It can be anticipated that, ultimately, centralized information providers, advertisers and others seeking to reach a consumer will bid directly for each information consumer's business or time depending upon that individuals market value to those trying to direct communication or advertising at specific consumers. The centralized information providers and or anyone seeking to communicate with a consumer will pay those information consumers who are particularly valuable directly or indirectly to consume the information provided for the consideration agreed. As the system matures centralized information providers will exist on thinner and thinner margins with more of advertiser funds being directed towards the consumer. In it's ultimate form the system contemplates no centralized information provider but rather each individual consumer or information consuming entity would be bid upon directly by those seeking to communicate with him and he would bid directly for content.

The information consumer, in this system, will, by necessity, be forced to share his financial spending patterns and biographical data and wealth profile with advertisers and those seeking to communicate with him. This will be accomplished through the establishment of databases of individual financial profiles and the linking of a financial transaction instrument, such as a credit card or debit card or any individualized unique identification, which would instantly record any purchases made by the consumer and transmit same to the centralized information provider who would maintain a database of such information. This function could be performed by entities separate from the centralized information providers. Each consumer in each discreet centralized information system will utilize a specific identification mark or identification code assigned to him which would allow the transmission of his financial data to separate advertisers to be, to some extent, confidential. This individual identification may be standardized across all centralized information providers. The potential advertisers or information transmitters will bid on a consumer as close to the time information is being consumed by the consumer as possible. A further aspect of the invention described herein is the ability of the advertiser or information provider to contract directly with the consumer for access to the consumer. The system contemplates, in one of its forms, direct bidding for consumers attention by advertisers or information content providers.

The system envisions the development of specific statistically derived data for each consumer, which would correlate with specific information such as the ratio of his purchases made which correlate to the advertising received as well as the amount of funds historically expended by the consumer and that consumer's age and wealth profile. It is necessary that the consumer's biographical and financial information be shared directly or indirectly through a entity specializing in this type of consumer information and sharing it with the centralized information provider, such that a historical profile for each consumer can be developed so that advertisers have measurement of the efficacy of the advertising submitted to each individual and that individual's consumption and financial profile. Furthermore, a comprehensive financial profile maintained for or by the information service provider of each consumer would allow them to maximize the advertising or communication dollar directed to each consumer. Those consumers who have more direct correlations between spending and advertising and/or who have more and greater spending patterns or greater wealth, can expect that advertisers would bid a higher price to reach these consumers versus those who have little correlation in their spending habits to advertising received or who have little money to spend. Those in the former group can be expected to receive direct compensation to listen or view specific communications or advertising while those in the latter category can be expected to pay up to one-hundred percent of the cost of non-advertising content provided to them. The money bid by advertisers to reach desirable consumers would ultimately, through competitive bidding by centralized information providers result in price competition being directed to consumers by advertisers or their proxy, the centralized information providers.

Thus, this patent allows for individual pricing for all information consumed. In its broadest form it allows for individual pricing on all commodities; because a consumer's biographical and financial profile, if revealed to potential merchants of goods and services, will result in greater and more individual price competition. Price itself as correlated with any good or service is a form of information. As the system described in this patent matures, all prices of any good or service will be subject to instant adjustment based upon the current market factors influencing prices as well as the potential consumer's current financial and biographical profile as revealed by his wealth and financial transaction history.

Another reason it is necessary that the financial and/or biographical information of the consumer be linked directly to the centralized information service provider (and through them to the advertisers) is so that market efficiencies can be maximized, i.e., why should advertisers spend money to advertise to people who do not respond to advertising? The more detailed and less anonymous the potential consumer's information that is shared, the more potential value he has to those wanting to direct communication to him or to direct individual pricing to him. He trades his privacy for money. Moreover, advertisers who spot economic inefficiencies in a consumers financial profile, can through advertising or direct communication share that information with the consumer, benefitting the consumer, the advertiser and the economy as a whole by making the economy more efficient, creating more wealth economy wide.

Likewise, those individuals with a different financial or biographical profile, i.e., great wealth or political power or a personal interest by one transmitting communication and/or a strong correlation between the advertising directed at them and expenditures made by then, will, ultimately, capture a greater percentage of the advertising or communication dollars directed to them. These individuals will have greater value to those seeking to communicate with them. Those that provide advertising or pay for access to consumers will pay more for these individuals time than for other individuals and ultimately information consumers should be able to capture directly some portion or all of the advertising or communication dollars directed to them. Individual pricing could also be directed at targeted consumers by merchants. Merchants will pitch different prices to different consumers for the same products because the consumer financial and biographical profile will make merchants more able to adopt flexible pricing strategies. This will benefit individuals and the economy as well by creating more pricing efficiency which will result in greater specialization, production and consumption and thus greater wealth throughout any economy in which the system described herein exists.

The linkage of the transaction instrument and consumer financial information and biographical information generally with the centralized information provider and advertisers, or merchants, or any entity seeking to communicate to specific individuals is necessary to develop statistical profiles and correlation coefficients between the advertising dollar expended and the actions taken by specific individuals. It is necessary to reveal consumer consumption and purchasing preference. It is necessary to set and maximize the market value of the content transmitted by those seeking to communicate with a communication or information consumer and those seeking his attention. It is also necessary to provide advertisers sufficient information on which to bid for an information consumer's time.

Because information content has an impact upon how advertising within that content is received, it can be anticipated that certain information, i.e., popular programs or news transmitted at the height of a crisis, has higher value than other more mundane information content. This will allow those with higher value content to receive compensation in proportion to the information's value in the marketplace depending upon the market value of the information content at the time it is transmitted.

The system demands that consumers contractually allow advertisers to access their historical financial and biographical data. It also demands that consumers agree to consume advertising or communication content in some manner. The method chosen could be the currently standard internet advertising that accompanies a downloaded internet file or the standard advertising that accompanies radio or television broadcasts or newspapers or any other method for consuming information content. It could also be a stand alone advertisement. But the centralized information provider must specify a specific method contractually by which the consumer shall receive advertising or content bid upon by the sender and the consumer must agree to the system's parameters to participate in the system.

Likewise, any advertiser or information content provider must contractually agree to the specifications of the system provided.

Any content provider wanting to participate must agree to provide content to the centralized information provider. In return he shall receive an agreed consideration for his content. This patent application contemplates a competitive market for content and anticipates in one of its forms that content providers will receive a percentage of the advertising money spent on the advertising which accompanies its content. Centralized information providers will pay content providers and, in a competitive market for content, centralized information providers will bid for content from content providers. Information consumers can also bid for, or pay a price for content. Content providers will receive a portion of the consideration resulting from the use of their content. Because centralized information providers must attract consumers to the advertising being presented on their communication system they will be forced to bid against each other to provide desirable content to attract consumer attention to their system. Content providers could agree to participate in any centralized information providers system for disseminating information, or not, depending upon whether or not the content provider agrees to the method of compensation offered. If they do not agree to the method of compensation offered, they can sell their content to a centralized information provider they can agree with on compensation. Thus, the system contemplates a market based or auction pricing system for general content as well as for advertising. This will allow individual content providers to access information consumers and, through the centralized information provider, receive compensation either in the form of a percentage of advertising revenue or a percentage of the consideration paid by content consumers to view the content or in some other method established in the contract between content providers and centralized information providers.

A consumer can choose to share as much or as little about his spending and financial profile as he wants. He can use cash as an anonymous alternative to a transaction instrument. However, the more information he shares and the more detailed his purchases and wealth history becomes, the greater the value he has to advertisers and those seeking to communicate with him and the more he will receive back from centralized content delivery providers, advertisers or merchants in the form of compensation. For instance, if he notifies merchants or their advertisers directly or through his centralized information provider that, he is currently looking at buying a new vehicle within a certain time period, say six months, and if his prior shared information correlates well with actual purchases made, advertisers seeking to sell automobiles would bid more to put advertising in front of him. It could further be expected that advertisers would also offer price discounts at the time of the advertiser's transmittal in an additional effort to capture that potential consumer sale.

Ultimately, the efficiency of the system depends upon advertisers being able to bid on specific people consuming content at specific times. That involves essentially an open line of communication at or near the time information is consumed directly from the information consumer to the centralized information providers and back to the prospective advertisers such that the advertisers know when an individual is in fact consuming information. The time of information consumption can be measured nearly exactly in some cases (internet) and approximated in others (newspapers). It will be necessary for every individual to acquire a specific individual identification which could be in different forms depending upon the centralized information provider and the method used for transmitting the information. Utilizing a password or passcode and account number, fingerprints, unique body parts or other identification which would register with the central information provider at the time the individual is consuming information would allow individual advertisers to bid at that moment or in anticipation of that moment for advertising time with that consumer. In a totally open and non anonymous system a person's or entity's actual name or image could be the necessary mark of identification. A fingerprint or body part recognized by the system could also suffice.

This process will by necessity, make necessary the development of an entirely new type of industry i.e. the information auction specialist. That industry, individual, individuals or automated device will monitor information content consumption as it occurs directing advertisers to bid on an individual information consumer's time. In other words, advertisers can bid against each other at or before a specific moment an individual is consuming information to allow the maximum value of the advertising to be obtained. The market specialist working for the centralized information provider will open an auction at or before the time a consumer or consumer commences consuming information. The efficiencies of this system allow some and ultimately most if not all of the money spent on advertising by advertisers to flow through to the information consumer. This is because, ultimately, information service providers will through competition render their profit margins smaller and smaller and those consumers who are involved in such a system will have the value of their time compensated by the market according to the value of their consumption patterns as set forth in this patent.

The application of this system to a telephone based centralized information provider illustrates the unique possibilities of this system. In a system such as described in this patent, individuals could choose to answer their telephone or not depending upon the price bid for their time by the person placing the phone call. So, for example, people could in fact could refuse to talk to anybody on the telephone who did not bid enough for their time to satisfy the person who would answer the phone.

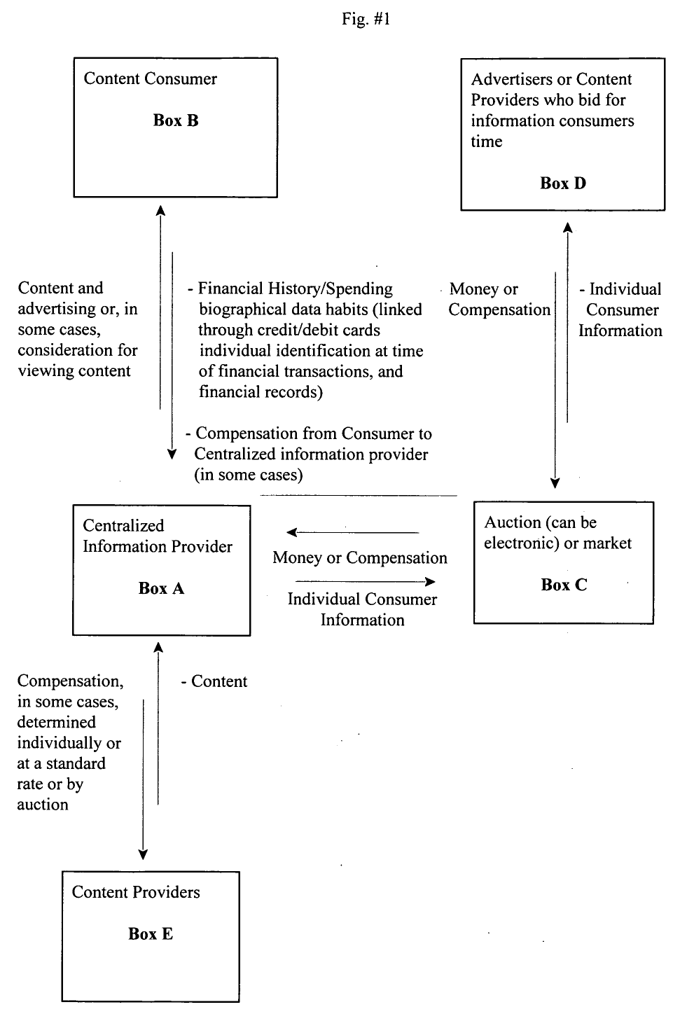

### Operation—Preferred Embodiment—FIG. 1

A preferred embodiment of the process is shown in the attached flow sheet drawings. The centralized information provider is denoted in Box A. The centralized information provider contracts with a content consumer, as shown in Box B. The centralized information provider will provide content, advertising and/or, in some cases, other consideration (monetary or otherwise) to the content consumer for viewing content. The content consumer in Box B provides compensation to the centralized information provider in the form of monetary payments or other considerations of value such as information about that content consumer's financial history and spending habits, both general biographical and income data, which will be provided to the centralized information provider through transaction credit/debit cards and other financial transaction recordkeeping devices and databases.

Compensation will also be provided from the consumer to the centralized information provider in certain instances in the form of monetary compensation.

The specific ratio of consideration in the form of monetary payments from the centralized information provider to the content consumer and vice versa will be unique for each consumer to the extent that each consumer has individual and unique value to advertisers and their intermediaries the centralized information providers. Therefore, each centralized information provider competing with each other will offer content consumers information services for a price determined by that centralized information provider to be an appropriate business decision. Particularly valuable content consumers who are particularly valuable to advertisers will be paid to consume advertising. Those on the other end of the scale, i.e., not valuable at all to advertisers will have to pay for all of the content they consume. The mass of people in between the two extremes will either pay a proportion of the cost of the content they consume or will receive less in monetary compensation from the centralized information provider than those more valued to advertisers. Thus, the price of content to each content consumer will be a market based determination as a result of competition. The ultimate value of a content consumer to advertisers is determined through the marketplace generally, but specifically is determined by a market or by an auction for the content consumer's time, which is shown in Box C. An auction can be performed manually by a human or automatically by an electronic device, such as a computer, which is programmed to accept the appropriate, usually the highest, bid for a specific content consumer's time.

Ultimately, the value of the content consumer's time to advertisers is determined by the advertisers themselves who are denoted in Box D. These are the individuals or entities which will bid upon the content consumer's time. The advertisers pay money or other compensation to the centralized information provider through the form of the high bid auction procedure or pursuant to a market derived price. The advertisers are able to bid efficiently on the content consumer's time because of the individual consumer information that is shared with them and upon which they base their advertising decisions.

Writers or other individuals publishing works of creative art, literature or any writing or other creative output for consumption are shown in Box E. These individuals will be paid by the centralized information provider to the extent that those content provider's content has market value and to extend that content providers agree to the centralized information provider offered compensation. Thus, the centralized information provider will contract with content providers to provide content on terms negotiated between the content provider and the centralized information provider. The agreement for compensation between the centralized information provider and the content provider can be myriad from a simple flat or percentage of revenue payment to a more specific mechanism where the content provider is compensated according to the number of content consumers consuming the content providers content. The content providers shall be compensated in some proportion to the advertising dollars or revenue their content generates. Thus, after this process is adopted, the market will determine what an appropriate payment to the content provider for his creation and content will be. It can be anticipated that famous and highly in demand content providers will command a premium compared to an unknown content provider or the rank amateur. On the other hand, if the rank amateur's content is particularly compelling, for instance in the form of previously unreported news of wide spread general interest or a compelling video or photograph, that could not be the case.

The consideration paid to content providers can be determined pursuant to auction or through general market forces.

An auction for content could be opened at any time by any possessor of valuable content of whatever type. An item of news itself could be auctioned to anyone or entity seeking to transmit it. The bidder could be a centralized information provider as described herein.

### Description—Alternative Embodiment

The electronic transactions identification instrument described in the preferred embodiment has a secondary use which provides benefits to vendors, as well as potential purchasers. By allowing instantaneous credit and financial and biographical history on any consumer to be transmitted to a vendor at or before the point of purchase of any item, a consumer and a merchant are in a position whereby individual pricing can be directed at that consumer prior to or at the point of sale. Presently, for instance, retailers in many product lines offer pricing discounts to less wealthy groups or individuals. For instance, supermarket chains typically will have slightly lower pricing and a different product mix to appeal to lower income consumers in lower income neighborhoods. Thus, supermarkets will often have different price schedules for different areas depending upon the economic circumstance of its clientele. This concept is useful for the supermarkets because they can make additional marginal profits (albeit at lower marginal rates) to these lower wealth and income consumers by making sales they would not otherwise make. Presumably, some of the sales would not have been made if the prices were not lower for those consumers.

This concept can be expanded through the use of the transactions instrument described in the previous section. What this patent provides, however, is the ability for the merchant, at a moments notice, to evaluate a potential sale and decide whether or not he wants to alter a price or not. The merchant can set any number of prices on the same good or service. This system can be used by any retailer or vendor of any type and it will result in more sales if properly utilized. The system described herein in this alternative embodiment, is shown in the figures in Exhibit 2 attached hereto.

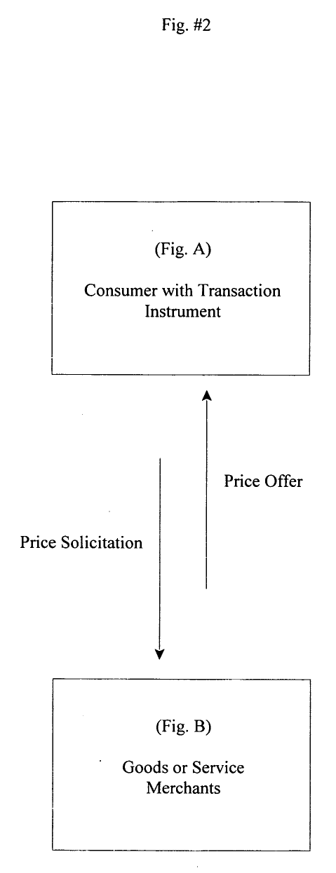

### Operation—Alternative Embodiment—FIG. 2

The system in its alternative embodiment is simple. A consumer (Fig. A) solicits a price on a specific good or service from a merchant (Fig. B). At the time the consumer relays his solicitation request, he also shares his financial information through his transactions instrument. The merchant then, based upon the consumer's financial information as conveyed by the consumer's transactions instrument, sets a unique price for the consumer soliciting the price. The consumer then either accepts or rejects the merchant's proffered price.

### Description—Second Alternative Embodiment

The invention described in this patent application has an additional embodiment separate from those already described herein.

Every individual or individual entity in the world is a potential consumer. That individual may also have value to other individuals or entities seeking to communicate with that individual. Thus, the invention described in this patent can be, in an alternative embodiment, utilized to set the value of an individual's consumption of specific advertisements or communication sought to be transmitted to a specific individual. The individual being solicited to consume information however, must receive a specific and acceptable to him monetary bid for that consumer's attention or time. The information consumer can then decide whether or not to consume the advertising or content. He must decide whether the proffered consideration offered by the individual or entity seeking his attention is adequate. If it's not, the perspective information consumer can simply say no to the offer, soliciting another offer perhaps or simply saying no to any such further offers.

The system in this embodiment also allows individual merchants or others to reach specific potential consumers by essentially paying for their time directly.

The system can also be effective in other forms of communication. For instance, when a potential party or political candidate seeks a vote from a specific voter, they can bid for that individual's time in consideration that consumer's consumption of any type of communication that party or candidate wants the potential voter to review.

Likewise, a potential lover or spouse can contact the object of his desires and can offer compensation to attract that individuals attention.

Certain high value consumers to specific certain high value individuals who have a particularly high value to specific individuals or entities to communicate with them will command greater premiums for their time then other more ordinary individuals. For instance, a very famous industrialist with tremendous demands on his time may be faced with numerous potential parties seeking to communicate with him bidding for his time. On the other hand, a newborn child with no ability to interact or understand a potential caterers vendors sales proposal have no or little value to the marketplace in general.

### CONCLUSION, RAMIFICATIONS, AND SCOPE

Accordingly, the reader will see that, according to the invention as set forth herein, I have provided a system which totally integrates any communication system such that all the potential market efficiencies of information provided and consumed can be maximized in any market.

While the above description contains many specificities, these should not be construed as limitations on the scope of the invention, but as exemplification of the presently preferred embodiments thereof. Many other ramifications and variations are possible within the reach of the invention. For example, if information content transmission becomes nonelectronic, or changes substantially from those known today, this system can still be utilized.

Thus, the scope of the invention should be determined by the appended claims and their legal equivalents, and not by the examples given.

1. A method for commoditizing information comprising:
a. ascertainment of the value of advertising content to advertisers directed to specific customers through market based or auction pricing; and
b. Ascertainment of the value of non-advertising content directed to specific consumers through market or auction determined pricing; and
c. integration of the market based or auction derived value of a specific consumer to advertisers with the market based or auction derived value of nonadvertising content directed to specific consumers through centralized information providers.

2. A method for enabling consumers of advertising to capture all or a portion of the funds expended by advertisers to attract that consumer's attention comprising;
a. ascertainment of the value of advertising content to advertisers directed to specific customers through market based or auction pricing; and
b. ascertainment of the value of non-advertising content directed to specific consumers though market or auction determined pricing; and
c. integration of the market based or auction derived value of a specific consumer to advertisers with the market based or auction derived value of non-advertising content directed to specific consumers through centralized information providers; and
d. a transaction instrument the use of which prior to consumption of advertising or non-advertising content by a specific consumer alerts potential advertisers of the specific consumer's financial and biographical profile and that specific consumers availability to consume advertising; and
e. an auction based or market based pricing agreement between non-advertising content providers and centralized information providers.

3. A method for providing individual pricing to individual consumers comprising;
a. a transactions instrument which encapsulates a potential consumer's recorded biographical and financial data prior to a purchase decision and which conveys to a merchant a prospective consumer's recorded financial and biographical data such that a merchant can utilize this data to offer that specific consumer an individual pricing offer.

4. A method for commoditizing information through the use of market based or auction pricing to determine the value of all content consumed by specific information consumers.
